(19) United States
(12) Patent Application Publication
(10) Pub. No.: US 2023/0345927 A1
(43) Pub. Date: Nov. 2, 2023

(54) Handheld Pest Control Device

(71) Applicant: Jay Hirsch, Van Nuys, CA (US)

(72) Inventor: Jay Hirsch, Van Nuys, CA (US)

(21) Appl. No.: 18/168,024

(22) Filed: Feb. 13, 2023

Related U.S. Application Data
(60) Provisional application No. 63/337,205, filed on May 2, 2022.

(51) Int. Cl. A01M 3/02

(52) U.S. Cl. CPC A01M 3/022

(57) ABSTRACT

The present invention relates to a novel handheld pest control device. The device is designed to eliminate or remove spiders, insects, pests, etc. from a living space. The device has an elongated rod, a base, and a hinge that allows the device to eliminate and remove the unwanted pest from a surface. Users can easily position the base over the unwanted pest, press down to eliminate the pest, and remove the unwanted pest to maintain cleanliness and safety in a living space.

### CROSS-REFERENCE TO RELATED APPLICATION

The present application claims priority to, and the benefit of, U.S. Provisional Application No. 63/337,205, which was filed on May 2, 2022, and is incorporated herein by reference in its entirety.

### FIELD OF THE INVENTION

The present invention relates generally to the field of pest control devices. More specifically, the present invention relates to an improved insect elimination tool that provides users with a new handheld unit that allows users to easily eliminate spiders or other insects crawling on an undesired surface and in difficult to reach areas. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in insect elimination or personal pest control devices. Standard insect swatters, sprays or powders can be helpful in attempting to eliminate spiders and other insects in the home, office, or other space; however, some insect swatters may not fully kill or eliminate the spider, insect, or other pest and the pest may escape and continue to be an annoyance. Furthermore, utilizing sprays or powders often introduces harmful chemicals into the home or other setting where people and pets may be exposed to the chemicals. Additionally, allowing these spiders, insects, and pests to remain in the home are undesired and could result in bites, infections or rashes that could require medical attention and at the very least, presents an irritation to the individual.

As stated supra, although insect swatters are generally effective for eliminating insects from the home, office, or other setting, they do not serve the intended purpose for spiders and other larger insects, e.g., the swatter may not fully kill or eliminate the undesired intruder. Further, a user desiring to eliminate a spider or insect may then resort to sprays or powders that introduce harmful chemicals into the home, office, or other area where people or pets may be located. In addition, traditional manual pest control devices are usually limited in length and require some level of stealth to be able to attempt to kill the pest. Each of the above scenarios could give rise to either the spiders or insects continuing to inhabit the home or result in the introduction of harmful chemicals into the home, office, or other setting and it is thus an object of this invention to at least ameliorate the issues associated with these situations. As such, the disclosed handheld pest elimination tool relates to an improved insect control device, which acts to ameliorate each of the above-described situations.

Thus, it is necessary for users that desire to have the ability to eliminate and control spiders and other insects from being in the home, office, or other area where people of pets are located to have a more effective tool for eliminating or controlling insects while not introducing harmful chemicals into the home, office, or other areas where people or pets may be located. Generally, fly swatters are common pest control tools in homes, offices, and other settings, but present difficulties in eliminating spiders and other insects, as they may not succeed in eliminating the spider or insect and allow the insect to continue inhabiting the space or area. However, many users need a handheld manual control device that will serve to eliminate spiders and other insects.

Therefore, there exists a long-felt need in the art for a handheld, elongated pest control device that provides users with a tool or accessory to easily eliminate spiders or other insects to improve overall insect control, cleanliness, and mitigate the use of harmful chemicals in living spaces. There is also a long-felt need in the art for a handheld manual pest control tool that features a dowel or elongated rod that can be held in the user's hand. The elongated rod is connected to a base by a swivel, pivot, or hinge mechanism. Further, there is a long-felt need in the art for a handheld pest control device that allows the base to lay flush against any surface at various angles through the functionality of the hinge or pivot mechanism. Additionally, there exists a long-felt need in the art for a handheld pest control tool that allows individuals to utilize the device to reach different heights or other distances while working to eliminate spiders, insects, or other pests, or to clean hard-to-reach spaces. Moreover, there is a long-felt need in the art for a pest control tool that prevents insect infestations and limits or avoids the use of harmful chemicals in living spaces. Also, there is a long-felt need in the art for a tacky film or other paper that covers the base or head of the pest control tool to allow the insect to adhere to the base or head and be successfully eliminated or removed from the surface. Additionally, there is a long-felt need in the art for a cleaning pad that can adhere to the base or head of the device and assist in reaching and cleaning the area after the insect, spider, or pest is eliminated or removed. Further, there is a long-felt need in the art for a handheld pest control device that improves overall insect elimination and helps users to effectively kill or remove the spider or insect and dispose of it in a safe and sanitary manner. Finally, there is a long-felt need in the art for a handheld pest control and cleaning tool that is effective at eliminating spiders, insects, and pests from the home, office, or other areas where people and pets may be found and avoids the need to rely on eliminating the spider or insect with a hand, tissue, or cloth.

The subject matter disclosed and claimed herein, in one embodiment thereof, comprises a handheld pest control device. The tool is designed to allow for spider and insect elimination while also avoiding the use of harmful chemicals in a home, office, or other setting where people and pets may be found. The pest control tool includes an elongated rod, which may have a telescoping section to extend the length of the rod, a hinge or pivot mechanism, and base or head component. The rod may include a bright white or bluish light element to attract the insect or pest to the tool for controlling the pest or insect. The base or head component is made of a firm or rigid material including, but not limited to, wood, high-density polyethylene, polystyrene, or metal and has a supporting wall. The base component connects to the rod through the hinge or pivot mechanism. The hinge or pivot mechanism functions to allow a user to place the base or head over the targeted spider or insect and as the user directs the device towards the targeted spider, insect, or pest using the pest control tool, the base will naturally angle over the targeted spider/insect, eliminate it, and lay flush against a surface. The light may be used to hold the spider, insect, or other pest in position. Users can easily position the base over the targeted spider or insect and utilize the rod and hinge mechanism to push the base or head against the targeted spider, insect, or pest to eliminate it. The tacky film and cleaning pad that are accessories to the handheld pest control tool serve to maintain cleanliness after the spider, insect, or pest are disposed of by the user.

In this manner, the handheld pest control tool of the present invention accomplishes all of the foregoing objectives and provides users with a device that improves overall spider, insect, and pest control or elimination, and helps users prevent the need for introducing harmful sprays or powders into the home, office, or other setting where people or pets may be present. The pest control tool allows an individual to utilize the handheld pest control tool and base or head, together with the hinge or pivot mechanism to effectively eliminate or control undesired spiders, insects, and pests. The hinge or pivot mechanism allows the user to eliminate undesired spiders, insects, and pests from a variety of surfaces to maintain a clean and pest-free living space.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a handheld pest control tool. The device is designed to allow for spider and insect elimination while also reducing the need to use of harmful chemicals in a home, office, or other setting where people and pests are located. The pest control tool includes an elongated rod, hinge, or pivot mechanism, and base or head component. The base or head component is made of a firm or rigid material, including but not limited to, wood, high-density polyethylene, polystyrene, or metal and has a supporting wall and connects to the elongated or telescoping rod through the hinge or pivot mechanism. The hinge or pivot mechanism functions to allow a user to place the base or head over the targeted spider, insect, or pest and, as the user directs the device towards the targeted spider, insect, or pest using the elongated rod, the base will naturally angle over both the targeted spider or insect, eliminate it, and lay flush against a surface. Users can easily position the base over the targeted spider, insect, or pest and utilize the rod and hinge or pivot mechanism to push the base against the targeted spider, insect, or pest applying sufficient pressure in order to eliminate the pest. The head or base may be provided with a compression spring which can be compressed to a first position and then when the head or base touches the surface, the compression is released to a second position and the head or base uses the compressed spring to apply additional force to the surface where the pest is located.

In one embodiment, the elongated rod component in one embodiment is a thin, round component that is several feet in length and manufactured from wood, polyethylene, metal, or combinations thereof. The rod component can be made from any suitable material as is known in the art. The elongated rod component can be of varying thicknesses and lengths and may have a telescoping element to allow the rod to extend to additional lengths. At one end, a user's hand can grasp the device by a handle having a gripping surface and the other end connects to the hinged component which in turn, connects to the base or head element. Typically, the diameter of the elongated rod component is narrower at the end near where a user's hand can grasp the device which may be facilitated by a gripping area, such as a rubberized area that may be ribbed; the diameter of the dowel rod component is greater at the end near the hinge or pivot component that connects to the base or head component.

In another embodiment, the base component is typically square or rectangular in shape but can be any suitable shape and size as is known in the art depending on the preferences of the individual. The base or head component has two or more layers including a supporting wall and the base wall. Each edge of the supporting wall is typically shorter in length than the base wall and the perimeter of the supporting wall is also shorter in length than the perimeter of the base wall. The supporting wall is mounted or affixed to the base wall. Both walls are manufactured from wood, polyethylene, metal, or combinations thereof. The base component can be manufactured from any suitable material as is known in the art.

The hinge or pivot component connects the rod and the base or head component to form a hinge or pivot mechanism to move the head or base. A first fixed component and second fixed component are attached to the base or head component. More particularly, the mounting for the rod component to the two fixed components is completed by creating a hole through the diameter of rod that is closest to the base or head component. A shaft is inserted through the first fixed component, rod, and second fixed component to create an axis over which the rod will be capable or moving or rotating to create a hinge or pivot mechanism. Clearly, alternative securing means also may be provided for this purpose.

Further, when the handheld pest control tool is in an operative configuration with the base or head angled flush against a surface, the base or head is allowed to make contact with the targeted spider, insect, or pest and contain it. The base or head is directed by the individual by the rod component. Then, when the rod supports the base or head component, and the head or base is placed against the surface or wall, the hinge mechanism functions to permit the base or head to lay flush against the surface, including a floor, wall, ceiling, or other surface. The base can lay flush against a surface through the functionality of the hinge or pivot mechanism which allows the individual to effectively eliminate the undesired or targeted spider, insect or other pest. With the device positioned as defined, and with the base or head in place over the undesired spider, insect, or other pest, the user can eliminate the undesired pest. Thus, the handheld pest control tool is positioned to effectively eliminate undesired pests, and avoid the introduction of harmful chemicals into a living space.

In one embodiment, the handheld pest control tool may be formed of a wood, polymer material, plastic, metal, or any other suitable rigid material or combination thereof as is known in the art. Further, the accessories including the tacky film, may have any tacky resin or pressure-sensitive adhesive film or sheet, and the cleaning pad may have any cotton, synthetic, or other material that allows absorption. The adhesive may be an acrylic adhesive and may have removable or repositionable properties.

In another embodiment, the overall dimensions of both the rod component and the base component may be greatly variable and, may be determined based on the preferences of a user. Generally, in this regard, each side of the base component may be approximately between three to eight inches in length. The supporting wall and base wall may be approximately between one-tenth to one-quarter inch in thickness, but may be greatly variable and, in particular may be determined based on the needs and/or wants of a user. The rod component may be any length depending upon the needs and/or wants of the user.

In yet another embodiment, the handheld elongated rod device includes a plurality of indicia and/or graphics.

In yet another embodiment, a method of eliminating or controlling spiders, insects, and pests from the home, office, or other settings where people or pets are located without the need to use harmful chemicals is described. The method includes the steps of providing a handheld pest control device having an elongated rod component with a base or head component. The method also includes the steps of positioning the handheld pest control tool over a spider or insect. Further, the method includes pressing the base down against the spider or insect and against a surface utilizing the elongated rod component and hinge or pivot component. Finally, utilizing the hinge or pivot component to allow the base or head component to eliminate the targeted pest and lay flush against a surface.

In use, when eliminating a spider, insect, pest, for example, the handheld pest control unit will be displaced into its operative configuration and the base or head component is positioned over the spider, insect, pest toward the surface on which it lays. The user holds the elongated or telescoping rod component in one hand and directs the base towards the targeted spider, insect, pest. Through the use and functionality of the hinge or pivot component, as the base is directed towards the targeted pest, the hinge will allow the base to rotate to push against the pest and lay flush against the surface as the user continues to press the rod component toward the surface, such that the space between the pest, surface, and base is eliminated. The base or head may also include a compression spring which will apply an additional force to crush the insect or pest once the head or base is pressed against the surface. This allows the device to eliminate and remove the undesired pest from the living space. Additionally, a tacky film or cleaning pad can assist in easily removing the undesired pest through either the adhesive properties of the tacky film or the porous, absorptive nature of the cleaning pad. Accordingly, the base component, rod component, and hinge component together function to allow a user to successfully remove or eliminate an undesired pest from a living space and avoid the potential introduction or use of harmful chemicals that would otherwise need to be used.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the handheld pest control unit of the present invention in accordance with the disclosed architecture;

FIG. 2 illustrates a perspective view of one potential embodiment of the handheld pest control tool of the present invention with a close-up perspective view of the hinge or pivot component in accordance with the disclosed architecture;

FIG. 3 illustrates a perspective view of one potential embodiment of the handheld pest control unit of the present invention wherein the tool is in an operative configuration in accordance with the disclosed architecture;

FIG. 4 illustrates a perspective view of one embodiment of the handheld pest control unit of the present invention in use with the base component pressed against a surface in accordance with the disclosed architecture;

FIG. 5 illustrates a perspective view of one embodiment of the handheld pest control unit of the present invention in use with the base component pressed against a surface with a close-up perspective view of the hinge or base component and base component in accordance with the disclosed architecture; and

FIG. 6 illustrates a side view of the head showing the pad of removable sheets and handle grip in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a handheld pest control unit that provides users with a tool to easily eliminate spiders or other insects to improve overall insect elimination, cleanliness, and avoid the use of harmful chemicals in living spaces. There is also a long-felt need in the art for a handheld pest control unit that features an elongated rod component which can be held in the user's hand and is connected to a base component by a swivel, pivot or hinge mechanism. Further, there is a long-felt need in the art for a handheld pest control unit that allows the base to lay flush against any surface at various angles through the functionality of the hinge mechanism. Additionally, there exists a long-felt need in the art for a handheld pest control unit that allows users to utilize the device to reach different heights while working to remove or eliminate spiders, insects, or other pests, or to clean hard-to-reach spaces. Moreover, there is a long-felt need in the art for a device that prevents insect infestations and limits the use of harmful chemicals in living spaces. Further, there is a long-felt need in the art for a handheld pest control device that improves overall insect elimination and helps users effectively kill, remove or eliminate the spider, insect, or other pest and dispose of it in a safe and sanitary manner. Finally, there is a long-felt need in the art for a handheld rod device that is effective at eliminating spiders and insects from the home, office, or other setting instead of relying on eliminating the spider or insect with a newspaper, magazine, hand, tissue, or other pest control item.

The present invention, in one exemplary embodiment, comprises a handheld pest control device. The invention is designed to allow for spider, insect, and other pest elimination or removal while also preventing the use of harmful chemicals in a home, office, or other setting where people or pets are found. The device includes an elongated rod, hinge or pivot mechanism, and base component. The base or head component is made of a firm or rigid material including, but not limited to, wood, high-density polyethylene, polystyrene, or metal. The head has a supporting wall and connects to the elongated rod through the hinge or pivot mechanism. The hinge or pivot mechanism functions to allow a user to place the base over the targeted spider or insect and, as the user directs the device towards the targeted spider or insect using the rod, the base will naturally angle over the targeted spider or insect, eliminate it, and lay flush against a surface. Users can easily position the base over the targeted spider, insect, or other pest and utilize the rod component and hinge mechanism to push the base component against the targeted spider, insect, or pest to eliminate it.

The present invention also includes a novel method of eliminating spiders, insects, or other pests to mitigate the introduction of harmful sprays or powders into the home, office, or other setting where people or pets may be. The method includes the steps of providing 600 a handheld pest control device comprising an elongated rod, hinge mechanism, and base component. The method also includes positioning 602 the handheld rod in a user's hand, extending the rod, if needed, through a telescoping feature. Further, the method includes the further step of holding the dowel rod component in a user's hand and hovering the base component over the spider, insect, pest, or dirt that the user seeks to eliminate and then pressing the base over that area. Finally, utilizing the base together with the rod component, the hinge component functions to allow the base to lay flush against a surface to eliminate the undesired spider or insect.

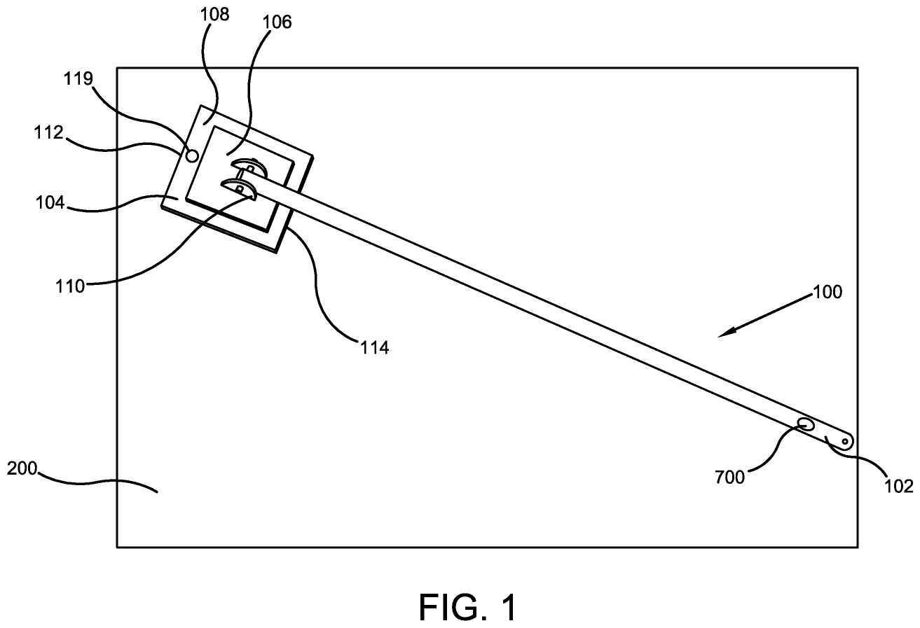

Referring initially to the drawings, FIG. 1 illustrates perspective view of one embodiment of the handheld rod 100 of the present invention. In the present embodiment, the handheld pest control device 100 is an improved insect removal device that eliminates spiders, insects, pests, and dirt while avoiding the use of harmful chemicals in the home, office, or other setting. The device 100 is especially designed to allow any user desiring to remove or eliminate spiders, insects, pests, dirt, and other pests, or any other suitable user as is known in the art to easily maintain an insect free area and mitigate or eliminate the use of harmful chemicals in a home, office, or other setting. More specifically, the device 100 includes an elongated rod 102 with a base component 104. The base component 104 has both a supporting wall 106 and a base wall 108. Users can easily hold the elongated rod component 102 and manipulate the base or head element 104 to remove or eliminate spiders and other insects from the home, office, or other setting where people or pets may be found. Further, the handheld rod device 100 can be used to eliminate spiders, insects or pests from a floor surface 200 and wall surface 202 and, utilizing the hinge component 110, can adjust to a desired angle. The elongated rod allows users to reach difficult to reach areas without the need to get on a ladder or chair or, to remove bugs from the floor without having to bend over.

Furthermore, the base or head component 104 has a plurality of layers which include a supporting or upper wall or platform 106 and a base wall or platform 108, which include opaque, firm elements. The supporting or upper wall or platform 106 and base wall 108 are typically square or rectangular in shape and are sized to be easily controlled and maneuvered by the elongated rod 102, however the supporting or upper wall or platform 106 and the base wall or platform 108 can be any suitable shape and size as is known in the art, depending on the preferences of a user. Any suitable number of supporting or upper walls or platforms 106 and base walls or platforms 108 can be utilized with the invention 100, depending on the preferences of a user. However, typically there are two walls, a supporting or upper wall or platform 106 and a base wall or platform 108 included in the invention 100. Further, the walls 106, 108 can be manufactured from any firm or rigid material as is known in the art. Typically, the supporting or upper wall or platform 106 would each be smaller in total perimeter and each side would be shorter in length as compared to the total perimeter and each side of the base wall or platform 108. The hinge or pivot component 110 would be adhered to the supporting wall 106. The supporting or upper wall 106 and the base wall or platform 108 would be adhered or secured to one another to create support for both the hinge component 110 and the elongated rod 102. The upper platform 106 has a size and perimeter that is less than the lower or base platform 108.

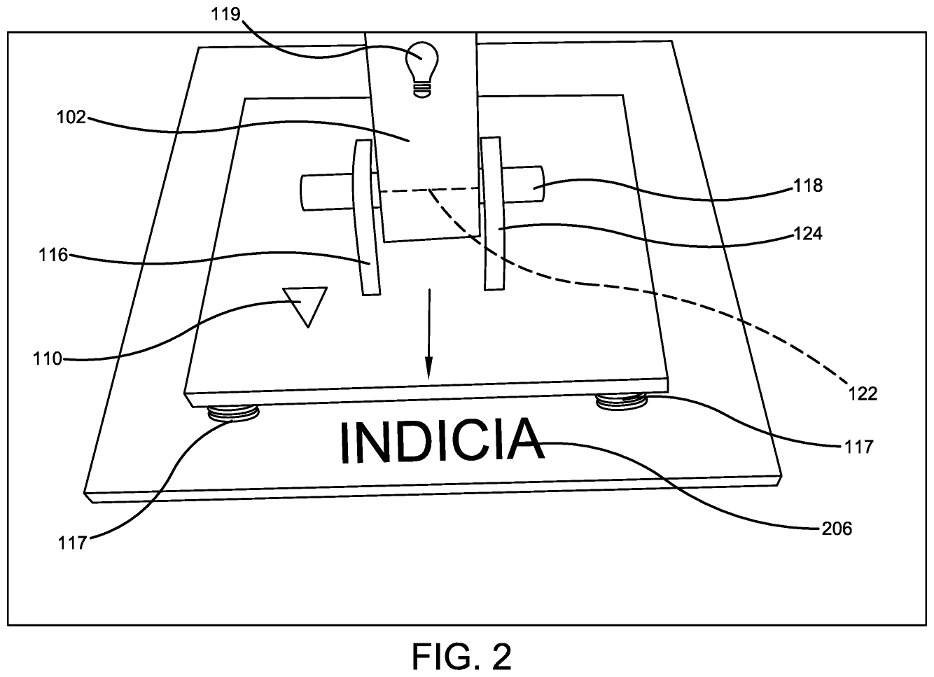

As shown in FIG. 2, the hinge or pivot component 110 is mounted on the base 104, more specifically, mounted to the supporting or upper wall or platform 106. The hinge or pivot 110 has a first fixed upright component 116, a second fixed upright component 120, a joint component 118, and the elongated rod component 102, which is movable. The pivot 110 may be a ball joint that allows the device 100 to move a plurality of angles. The first fixed upright component 116 and the second fixed upright component 120 are both mounted to the supporting or upper wall or platform 106 of the base component. The distance between the first fixed upright component 116 and the second fixed upright component 120 depends upon the diameter of the elongated rod component 102 as the rod component 102 will be inserted between the first fixed upright components 116 and the second fixed upright component 120. The first fixed upright component 116 and the second fixed upright component 120 extend perpendicularly upwardly from the supporting upper wall or platform 106. The first fixed upright component 116 and the second fixed upright component 120 each have a hole into which the joint component 118 can be inserted. The joint component will extend through a hole the first fixed upright component 116, through the elongated rod component 102, and through the second fixed upright component 120, forming the hinge component 110. The joint component 118 will be the axis 122 upon which the elongated rod component 102 rotates and moves along a perpendicular axis. Further, the inherent nature of the elongated rod component 102 and the joint component 118 allows for movement of the elongated rod component 102 to any position between the top edge of the base component 112 to the bottom edge of the base component 114. The upper platform 106 may also be provided with springs 117 to allow additional pressure to be applied to the platform 108. In addition, the elongated rod may have a light 119 which may be a bright white or bluish light to help attract the insects and keep them from escaping. In one embodiment, the light 119 may be positioned around the

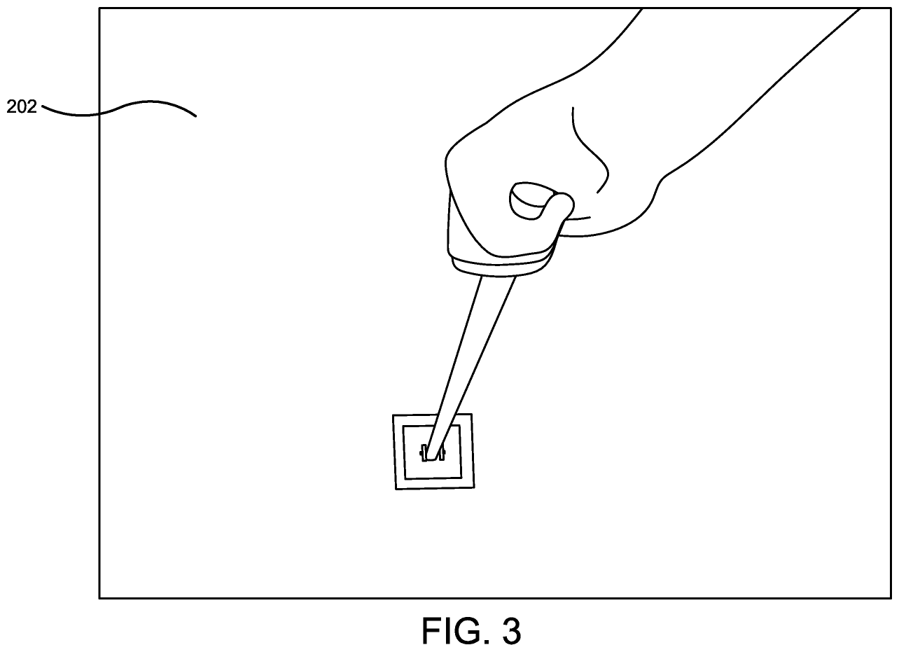

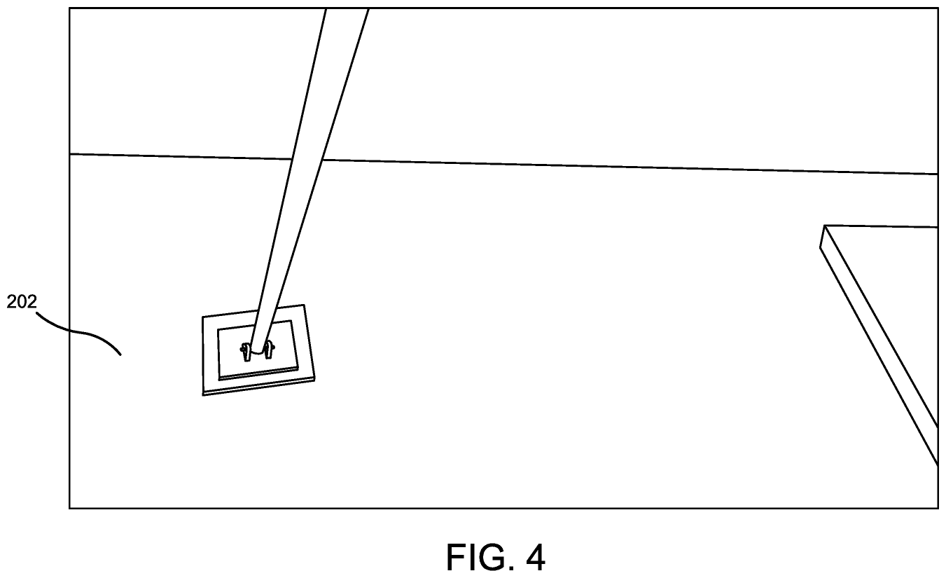

As shown in FIG. 3-4, the elongated rod component 102, in an operative configuration with the base component 104 laying flush against a wall surface 202, is positioned utilizing the hinge component 110 to allow the elongated rod component to direct the base component to be pressed against both the targeted spider or insect and the wall surface 202 to easily and safely dispose of the targeted item. The springs 117 may be used to help apply pressure to the wall surface so that the insect cannot escape out the sides of the invention 100. With the base component 104 positioned as defined and with the elongated rod component 102 in a user's hand and directing the base component 104, the user, holding the dowel rod component 102, will push the base component 104 over the targeted spider, insect or other item and allow the base component to rest flush against a floor surface 200, wall surface 202, or another surface. Thus, the base component 104 is positioned to effectively eliminate and remove a spider, insect, dirt, or other item and avoid the introduction of harmful chemicals into the home, office, or other setting.

In one embodiment, the invention 100 may be formed of various types of wood, metal, or plastic or polymers, such as polypropylene, polystyrene, or acrylonitrile-butadiene-styrene (ABS), or any other suitable material as is known in the art, such as, but not limited to, acrylic, polycarbonate, polyethylene, thermoplastic, polyethylene terephthalate, polyvinyl chloride, polystyrene, or combinations thereof, or any other suitable wood, metal, or synthetic plastic material as is known in the art. Further, the material that composes the handheld pest control device can be any suitable rigid material as is known in the art, such that it is effective at allowing the elongated rod component to guide the base component to successfully eliminate spiders, insects or pests from a surface.

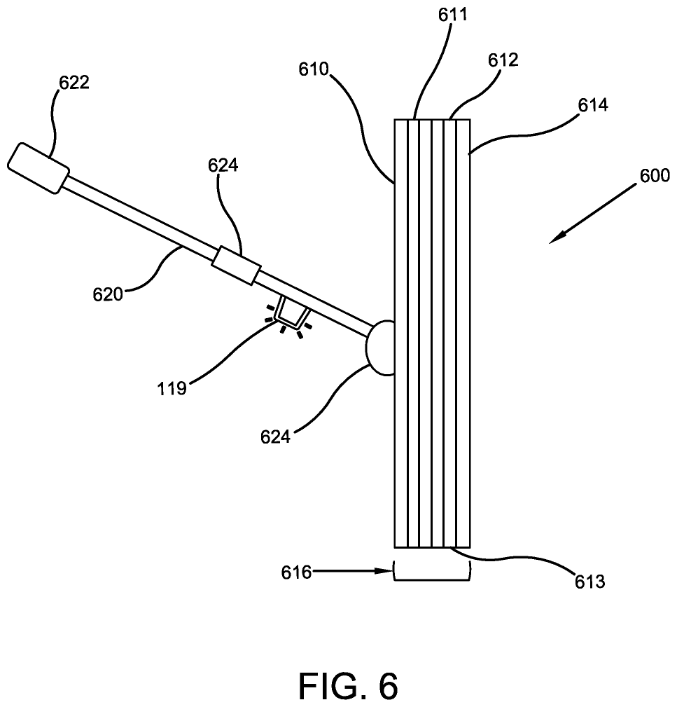

Further, the overall dimensions and the shape of the base component 104, although generally square in shape, may be greatly variable and, in particular may be determined based on the preferences of a user. Generally, in this regard, each side of the base or head component 104 (including the supporting wall or platform 106 and the base wall or platform 108) may be approximately between three to eight inches in length. The length of each side of the supporting wall 106 is approximately three-quarters of the length of each side of the base wall 108, but may be greatly variable and, in particular may be determined based on the preferences of a user. The supporting wall 106 and base wall 108 may be approximately between one-tenth to one-quarter inch in thickness, but may be greatly variable and, in particular may be determined based on the needs and/or wants of a user. The elongated rod component may be any length depending upon the preferences of the user but generally ranges from two feet to four feet and with the telescoping feature as shown in FIG. 6 the elongated rod can be extended to up to six feet.

In yet another embodiment, the handheld rod device 100 comprises a plurality of indicia 206. The base component 104 and/or elongated rod component 102 of the present invention 100 may include advertising, a trademark, or other letters, designs, or characters, printed, painted, stamped, or integrated into the base component 104 or elongated rod component 102, or any other indicia 206 as is known in the art. Specifically, any suitable indicia 206 as is known in the art can be included, such as, but not limited to, patterns, logos, emblems, images, symbols, designs, letters, words, characters, animals, advertisements, brands, or combinations thereof, that may or may not be pest control or brand related.

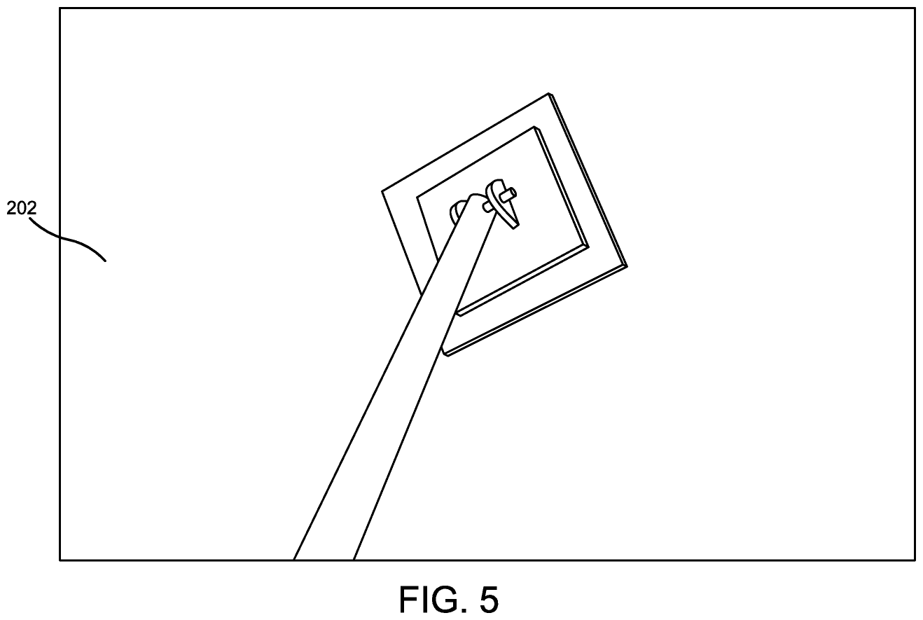

As shown in FIG. 5, in use, when pressing the base component 104 against a wall surface 202, the base component 104 will be displaced into its operative configuration and a user will be able to direct the elongated rod component 102 toward a wall surface 202, floor surface 200, or other surface, and through the functionality of the hinge or pivot component 110, the base will be able to lay flush against both the spider, insect, dirt, or other item sought to be eliminated. Additionally, utilizing 604 the hinge or pivot component 110, the base component 104 is allowed to both eliminate the targeted pest and lay flush against a wall surface 202.

FIG. 6 shows a side view of the pest control device 600 and head 610. The head 610 has a bottom surface which is opposite to the surface to which the elongated rod 620 is attached. The bottom surface 611 is provided with at least one adhesive sheet and preferably a number of separable layers of adhesive sheets 614 and release sheet 612 which positioned between each of the adhesive sheets 614 forming a pad 616. The release sheets 612 have tabs 613 on the edges to facilitate the peeling away of the spent sheet and exposing a new adhesive sheet. The tab 613 may be ¼″ to about ½″ in length to make it easier to peel up the sheet. The elongated rod 620 is movably connected to the head 610 at a pivot point 624. The elongated rod 620 has a telescoping element 626 which when twisted, allows the elongated rod 620 to be extended to an additional length and up to six feet. At the end of the elongated rod 620 is a handle 622 which may include a gripping element which may be a rubberized material with ridges. The handle 622 may have an antimicrobial material to prevent the transfer of germs from one user to another. The elongated rod 620 is also shown with a light 119 which can used to attract insects. The light 119 may be positioned around the perimeter off the base 104 in one embodiment. The light 119 is preferably an LED light that can blind/stun insects.

In one embodiment, the dowel rod 102 has at least one button 700 that is in wired electrical communication with the light 119. The button 700 allows a user to turn the light 119 on/off.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “handheld rod device” and “device” are interchangeable and refer to the handheld rod device 100 of the present invention.

Notwithstanding the foregoing, the handheld rod device 100 of the present invention can be of any suitable size and configuration as is known in the art without affecting the overall concept of the invention, provided that it accomplishes the above-stated objectives. One of ordinary skill in the art will appreciate that the handheld rod device 100 as shown in FIGS. 1-6 are for illustrative purposes only, and that many other sizes and shapes of the handheld rod device 100 are well within the scope of the present disclosure. Although the dimensions of the handheld rod device 100 are important design parameters for user convenience, the handheld rod device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pest control device comprising:
an elongated rod;
a base connected to the elongated rod at a hinge, wherein the elongated rod is repositionable perpendicular to the base; and
at least one adhesive sheet disposed on a bottom surface of the base;
wherein the elongated rod is attached to the hinge by a first upright component and a second upright component, and held in position by a joint component; and
further wherein the base is comprised of a supporting wall and a base wall, and the supporting wall and base wall are secured together.

2. The pest control device as recited in claim 1, wherein the at least one adhesive sheet is part of a pad of sheets.

3. The pest control device as recited in claim 2, wherein the pad of sheets is made up of a plurality of adhesive sheets.

4. The pest control device as recited in claim 3, wherein the plurality of adhesive sheets are separated with a plurality of release sheets.

5. The pest control device as recited in claim 4, wherein each of the plurality of release sheets is provided with a tab for removing a used adhesive sheet.

6. The pest control device as recited in claim 5, wherein the tab is between ¼ inch and ½ inch in length.

7. The pest control device as recited in claim 1, wherein the elongated rod comprises a light.

8. The pest control device as recited in claim 7, wherein the light is one of a bright white or a bluish light.

9. The pest control device as recited in claim 1, wherein the elongated rod comprises a telescoping feature.

10. The pest control device as recited in claim 1, wherein the elongated rod comprises a handle portion.

11. The pest control device as recited in claim 10, wherein the handle portion comprises a gripping area comprised of a rubberized material.

12. An insect removal tool comprising:
a head having a square or a rectangular configuration, wherein the head is connected to an elongated rod by first upright component and a second upright component and further wherein each of the first and second upright components are positioned perpendicular to the head;
wherein the elongated rod is repositionably held to the first and second upright components by a joint component;
wherein the head is comprised of a supporting layer and an upper layer, and the supporting layer is larger than the upper layer; and
further wherein the supporting layer is comprised of a bottom surface.

13. The insect removal tool as recited in claim 12, wherein a pad of sheets if positioned on the bottom surface.

14. The insect removal tool as recited in claim 13, wherein the pad of sheets comprises a plurality of adhesive sheets and a plurality of release sheets.

15. The insect removal tool as recited in claim 14, wherein each of the plurality of release sheets is positioned between a pair of the plurality of adhesive sheets.

16. The insect removal tool as recited in claim 12, wherein the elongated rod comprises a light.

17. The insect removal tool as recited in claim 12, wherein the elongated rod comprises a handle having a gripping area, and further wherein the gripping area is provided with an antimicrobial treatment.

18. The insect removal tool as recited in claim 16, wherein the light is one of a bright white or a bluish light.

19. A tool for insect control, the tool comprising:
an elongated telescoping rod comprised of a handle having a gripping area, wherein the gripping area is comprised of a rubberized material with an antimicrobial material;
a base having first and second upright elements, wherein the first and second upright elements secure the elongated telescoping rod to the base by a joint extending through an opening within the first and second upright elements and the elongated telescoping rod; and
at least one adhesive sheet positioned on a bottom surface of the base, wherein the elongated telescoping rod is pivotable about the base perpendicularly, and further wherein the base is comprised of an upper and supporting platform which are secured together and have a thickness of between one-tenth to one-quarter of an inch.

20. The tool as recited in claim 19, wherein the rod has a length of up to six feet and is comprised with a bright white light or a bluish light.
